(19) United States
(12) Patent Application Publication
(10) Pub. No.: US 2005/0189387 A1
(43) Pub. Date: Sep. 1, 2005

(54) Universal container for a vehicle trunk

(76) Inventor: Franco Fatigati, Roma (IT)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 10/512,179

(22) PCT Filed: Jan. 30, 2003
(86) PCT No.: PCT/IT03/00040

§ 371 Date: Oct. 22, 2004

(30) Foreign Application Priority Data
Apr. 23, 2002 (IT) RM2002U000071

(51) Int. Cl. B60R 9/00; B60R 11/00

(52) U.S. Cl. 224/497

(57) ABSTRACT

Container (1) for a vehicle trunk (B), comprising a base (2) and a plurality of side walls (4, 5, 6, 7), rotatably connected to the base so as to be movable between a lying position and an operative position at which, jointly to the base, they define a compartment (12).

The present invention refers to an universal container apt to be housed in the trunk of a vehicle, and in particular of a car.

In trunks of vehicles such as cars, vans and the like, the so-called motor vehicle trunks included, items of various shape, type and nature are generally housed.

However, a well-known drawback occurring during the vehicle ride lies in the fact that the items in the trunk tend to move, in particular being displaced from their original location, interfering the ones with the others and/or turning upside-down. This drawback is unacceptable in case some or all of the carried items be delicate and/or fragile, as those are at risk of serious damage induced by said movements. Moreover, items shifting in the trunk may distract a vehicle driver, in some cases possibly unbalancing the vehicle trim.

The provision, in some vehicles, of holding belts and/or of item containment webbings fails to solve all the drawbacks mentioned above. In fact, first of all such belts and webbings are apt to hold items of reduced encumbrance and mass only. Moreover, such holding means of the known art are fixedly preset in the vehicle trunk, typically at the side walls thereof. Hence, often items are anyhow free to move at the wider center portion of the trunk.

In the light of the above, a demand subsists for means for holding items housed in a vehicle trunk, which be alternative to those known to the art and allowing to overcome the drawbacks mentioned above.

Hence, object of the present invention is a container, apt to be housed in a vehicle trunk and allowing to meet this need.

This object is attained by a container according to claim 1.

The present invention provides some relevant advantages. The main advantage lies in the fact that the container of the invention allows a safe retaining of items of any shape, mass and encumbrance. Moreover, the container base may be blocked onto the trunk floor at any one position, providing numberless viable operative configurations. Additionally, by virtue of the rotatable connection between the side wall(s) and the base, the container of the invention may assume a reduced encumbrance configuration in which the side wall or walls be lying, substantially overlappable and parallel to the base and optionally folded thereon.

Other advantages, features, and the operation steps of the present invention will be made apparent in the following detailed description of some embodiments thereof, given by way of example and not for limitative purposes. It will be made reference to the figures of the annexed drawings, wherein:

FIG. 1 shows a partially sectional perspective view of a first embodiment of the container according to the present invention, in which the side walls are in a lying configuration;

FIG. 1A shows an enlarged detail of the container of FIG. 1;

FIG. 1B shows a sectional view of the container of FIG. 1, taken along line A-A of the latter;

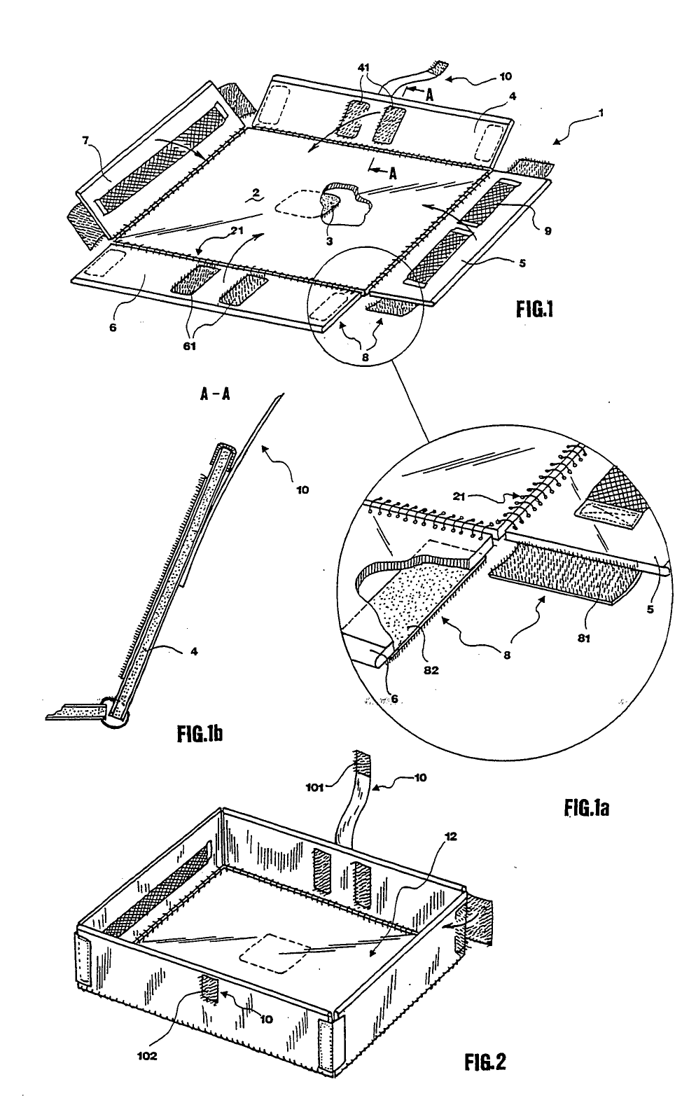

FIG. 2 shows a perspective view of the container of FIG. 1 in an operative configuration;

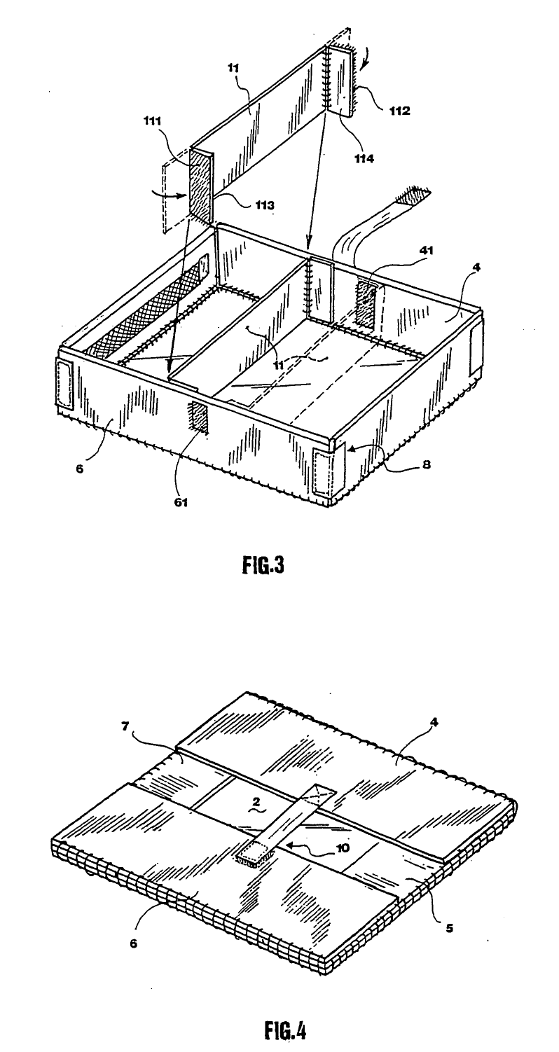

FIG. 3 shows a perspective view of the container of FIG. 1 in another operative configuration;

FIG. 4 shows a perspective view of the container of the invention in a minimal encumbrance configuration;

FIG. 5 shows a perspective view of the container of FIG. 1 installed on a car and filled with a plurality of items; and

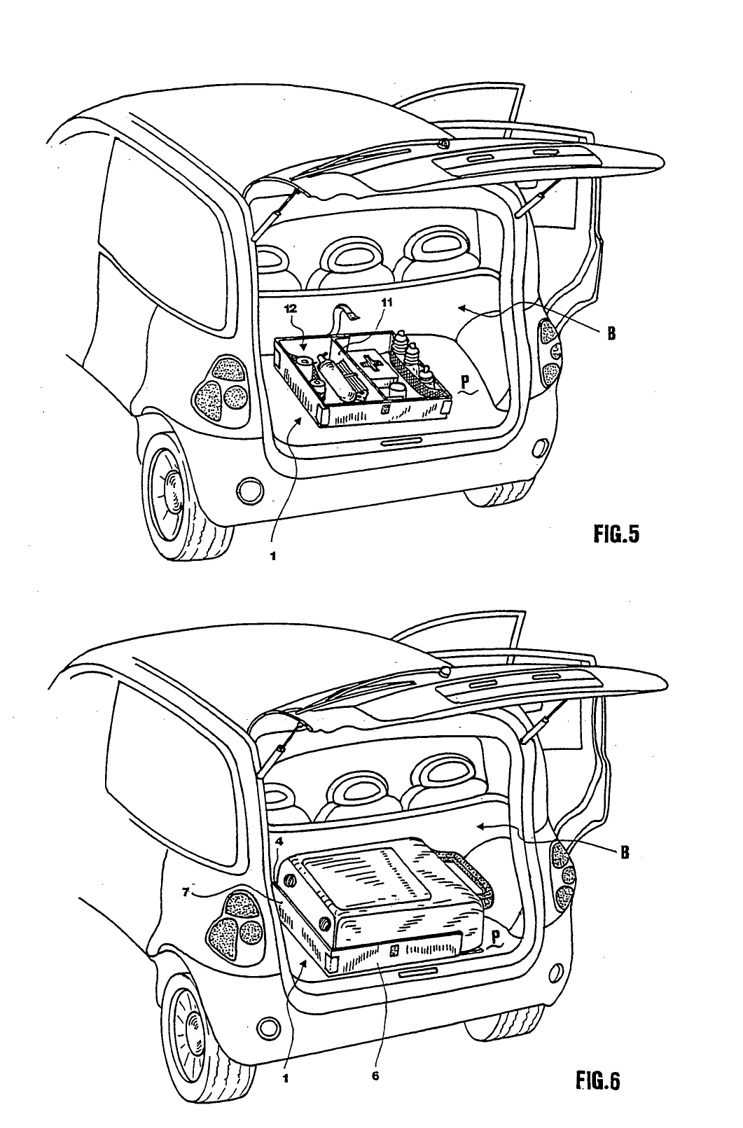

FIG. 6 shows another perspective view of the container of FIG. 1 installed on a car in a further operative configuration.

Referring initially to FIG. 1, a container according to the present invention is generally indicated by 1.

Firstly, the container 1 comprises a base 2, which in the present embodiment has a substantially rectangular shape when observed in a plan view.

The base 2 is apt to be reversibly blocked onto a resting surface, typically a flat floor, of a vehicle trunk, and in particular of a car. In the present embodiment, the container 1 is conceived to be employed on trunks having a floor lined with carpet or the like. Hence, such blocking of the base 2 onto the floor is attained by reversible fastening means, in particular one or more Velcro® elements 3 applied onto the base 2 at the bottom face thereof.

Although in the annexed figures a single Velcro® element 3 has been depicted centrally applied onto the bottom face of the base 2, said reversible fastening means can advantageously consist of one or more Velcro® strips, applied along the short or long sides of the base to attain a firmer grip.

Peripherally to the base 2, and in particular at the entire perimeter thereof, there are rotatably connected a plurality of side walls and in particular a first wall 4, a second wall 5, a third wall 6 and a fourth wall 7, each wall being connected, at the longer side of the end edge thereof, to a respective perimeter side of the base 2.

The walls 4, 5, 6 and 7 all exhibit a substantially rectangular shape when observed in a plan view. Moreover, the walls 4-7 are equal by twos, defining the side faces of a parallelepiped having the base 2.

In the present embodiment, said rotatable connection of the side walls 4-7 to the base 2 is obtained by a peripheral seam 21.

The container 1 further comprises reversible blocking means 8 apt to block the side walls 4-7 in an operative position, i.e. raised substantially orthogonal to the base 2. In the present embodiment, the means 8 consists of reversible engaging means located in correspondence of contiguous pairs of side walls 4-7 of said plurality.

In particular, as it is shown in greater detail in FIG. 1A, such means 8 is implemented by pairs of complementary Velcro® elements 81 and 82 fastened sideways on a respective pair of adjacent side walls, the second wall 5 and the third wall 6 in the example of FIG. 1A.

In particular, in the present embodiment each element 81 is shaped as a flap, which may extend along the entire side of the respective side wall or merely along a portion thereof.

Moreover, in order to make the connection between adjacent side walls firmer, snap fasteners, e.g. in metal, may be associated with or replace said complementary Velcro® elements.

Further referring to FIG. 1, preferably, at the inner face of at least one of the side walls, in particular the second and the fourth wall 5 and 7 in the present example, the container 1 comprises elastically strainable means for holding an item, in particular elastic belts 9.

As it is summarily sketched in FIG. 1B, in the present embodiment both the base 2 and the side walls 4-7 comprise a polycarbonate honeycomb core and a polyester outer coating. The base 2 and the walls 4-7 provide an inner lining and an edge ribbon onto the outer edges of the polyester walls. Always according to a preferred embodiment, such base 2 and side walls 4-7 have a thickness comprised in a range of about 1÷5 mm, even more preferably equal to about 3 mm.

Of course, the outer coating may be made of different materials, even of greater value, like e.g. cloth, alcantara or natural leather, to meet the finishing standards of the vehicle to be equipped, with the option of branding the outer as well as the inner walls.

Moreover, additionally referring to FIG. 2, the container 1 also comprises closure means 10 applied at two opposite side walls, in particular the first and the third wall 4 and 6 in the present example. Such closure means 10 are for blocking the container 1 in a minimal encumbrance configuration, shown in FIG. 4, in which the side walls 4-7 are completely folded onto the base 2 so that the container 1 is completely flattened on itself. Also such closure means 10 are implemented by two complementary Velcro® elements 101 and 102, each applied onto the outer face of a respective side wall of said two opposite walls, in particular first and third wall 4, 6, in an arrangement such that the two elements 101 and 102 are mutually engageable when said faces are overlapped in the minimal encumbrance configuration of the container 1.

Referring now to FIG. 3, always in the present example, the container 1 also comprises a partition wall 11 that is reversibly connectible between two side walls of the container 1 in the abovementioned operative configuration, and in particular between the first and the third wall 4 and 6. In the present embodiment, also such reversible connection is implemented by reversible engaging means, and in particular by two first Velcro® elements 111 and 112 of the same type, each fastened on a respective side flap 113 or 114 of the partition 11, and by second Velcro® elements 41 and 61 complementary to the first ones and fastened each at an intermediate position on a respective first or third side wall 4 and 6. As it is shown in FIG. 1, in the present example several second elements 41 and 61 are fastened on each side wall 4 and 6, thereby allowing to set the partition 11 in different operative positions, or even to concomitantly use more than one partition.

It will be understood that, according to a variant embodiment, said reversible engaging means provide that on each side wall involved, in this case the first and the third side wall 4 and 6, instead of said second Velcro® elements 41 or 61 there be applied a single Velcro® strip extending parallelly to the base. This variant simplifies the implementation modes of the container of the invention, concomitantly anyhow allowing to set the partition 11 into different operative positions or to use more than one partition at the same time.

Hereinafter, the operation modes of the container 1 will be illustrated, referring also to FIGS. 5 and 6. As mentioned above, the container 1 is apt to be housed in the trunk of any one vehicle, indicated by B in FIGS. 5 and 6, and in particular of a car.

First of all, the container 1 may be provided to end users in form of a kit comprising a main body, made of the base 2 and of the side walls 4-7 connected thereto, and of one or more partitions 11.

The container 1 may advantageously be packed with the side walls 4-7 folded onto the base 2 in the abovementioned minimal encumbrance configuration of FIG. 4, and with the closure means 10 of first and third wall 4 and 6 mutually engaged. It has to be remarked that FIG. 4 relates to a variant embodiment of the invention in which the side walls 4-7 have a greater height with respect to the container of the variant embodiment of FIG. 1.

The container 1 may be put away in the car, e.g. in the trunk itself, in such a minimal encumbrance configuration and opened only needwise. It will be appreciated that, even in the folded minimal encumbrance configuration, the fastening means 3 may be used to reversibly block the base 2 onto the trunk floor P, onto the backrest, or merely rested on the luggage rack.

In case items to be retained in a fixed position during the ride are to be carried, the container 1 is brought to an operative configuration. To this end, the base 2 is fastened, at a chosen location onto the trunk floor, by the reversible fastening means 3. Then, all or some of the side walls 4-7 are raised in order to bring them to said operative position, i.e. substantially orthogonal to the base 2. Adjacent walls are blocked in this position by said Velcro® elements 8.

The case in which all the side walls 4-7 have been rotated into an operative position is shown in FIG. 5. As it is illustrated therein, in such a case the four walls 4-7 and the base 2 define a substantially parallelepiped-shaped compartment 12. The latter, given the slidability of the partition wall 11 that is connected to the side walls 4 and 6 by the related Velcro( elements 111, 112, 41 and 61, may also be partitioned into two hemi-compartments of variable width, so as to hold in place different items independently and separately the one from the other.

Inside the compartment 12 there may be housed items of any nature whatsoever. In particular, a suitcase, a bag and/or a package may be centrally arranged within the compartment 12, whereas other more delicate items, like e.g. a bottle or a container in glass in general may be blocked against the second or the third side wall 5 or 7 by the elastic belts 9.

Of course, elastic holding means like said elastic belts 9 could be applied even onto the partition wall 11.

The case in which only some of the side walls 4-7 are rotated in an operative position is shown, of course purely by way of example, in FIG. 6. In the example of FIG. 6 the first, third and fourth wall, 4, 6 and 7 respectively, are actually rotated in a position orthogonal to the base 2, whereas the second wall 5 is rotated externally to the base 2, being adjacent and substantially coplanar thereto. In this type of operative configuration, the container 1 can hold in place an item of large dimensions, e.g. a suitcase.

For an even more sizeable object to be transported, only two contiguous walls may be brought to an operative position, thereby providing a greater useful containment area.

At the end of the employ, e.g. at the end of the ride, the container 1 may be brought back to its initial minimal encumbrance configuration. Of course, the container 1 may also be removed from the vehicle and find additional uses as item holder outside of the trunk.

It will be understood that the present invention is susceptible of several embodiments alternative to the hereto-described preferred one, some of which will briefly be illustrated hereinafter with reference to the sole aspects differentiating it from the hereto-considered preferred embodiment.

First of all, the base and the side walls of the container may be made integral the one to the others, and said rotatable connection may be obtained by suitable creasing lines.

According to another variant, the base and the side walls of the container may consist of distinct bodies, e.g. plastics material cores, coated with a common foldable lining implementing said rotatable connection between the base and the walls.

Moreover, such rotatable connection between the base and the side walls may be obtained by conventional hinges, e.g. of metallic type. Said hinges could also incorporate means for blocking the walls themselves in an erected, i.e., operative, position, hence with no need to provide the Velcro® elements 81, 82 of the abovedescribed preferred embodiment.

Furthermore, one or more side walls may be rotatably connected to the base not necessarily at the periphery thereof, but at an intermediate portion thereof as well, so as to define plural item-retaining compartments.

According to a further variant, the blocking of the base to the trunk floor may be obtained by means alternative to the abovedescribed reversible fastening means.

It will also be understood that, in a simplified variant embodiment, the container of the invention provides a single side wall rotatably connected to the base.

It will presently be appreciated that the container of the invention may be produced in an extremely simple and cost-effective manner. Furthermore, it should be pointed out that the cost of the invention may be partially or entirely met by the elimination of the current car-equipping devices, like webbings, hooks, metal eyelets or the like, which to date weigh on the production costs due both to the intrinsic value and to the on-board mounting thereof.

The container of the preferred embodiment and of the aboveillustrated variants is also durable, requires no maintenance and is easily cleanable.

Moreover, by virtue of the option of folding it in said minimal encumbrance configuration, the container is easy to transport.

Additionally, with the selection of the aboveindicated materials, or of mechanically equivalent ones, the container is very light-weight, and in particular, in the shape and dimensions as exemplarily reported, of a <800 g weight. However, in general the container is susceptible of being made of materials water-repellent, non-toxic and meeting current automotive standards.

It will also be appreciated that the container of the invention is extremely versatile. In particular, as mentioned above, it proves useful in numberless locations within the trunk, and it may also be used to carry out of the car the items housed therein, avoiding breaking of the load. Moreover, it may also be used on different cars, even on those having a naked trunk floor. In this latter case, the container could be blocked to the trunk itself by straps or elastic bands.

The container of the invention may also be used locating it on the front passenger seat to house items, files or refreshments to be consumed during the ride.

Moreover, the container may be located in the trunk of a car having a reclined rear seat.

The container of the invention may also be manufactured in different dimensions, to adjust to any type of surface, trunk, transported items, and vehicle.

The container of the invention may also be used on a floating vehicle, e.g. a boat, optionally prearranging a carpeted housing seat for fastening it.

The present invention has been hereto described with reference to preferred embodiments thereof. It is understood that other embodiments may exist, all falling within the concept of the same invention, and all comprised within the protective scope of the claims hereinafter.

1-14. (canceled)

15. A container (1), in particular apt to be housed in a vehicle trunk (B), comprising:
a base (2), apt to be blocked onto a resting surface (P) of the trunk;
a plurality of side walls (4, 5, 6, 7), each one rotatably connected at a respective end edge thereof to said base (2) so as to be movable between a lying position, wherein it is substantially parallel to said base, and an operative position, wherein it is substantially orthogonal to said base and in which the walls of said plurality define, together with said base, at least one compartment (12) for housing objects;
reversible blocking means (8), apt to block each wall of said plurality in said operative position; and
at least one partition wall,
characterized in that said at least one partition wall (11) is reversibly connectible and disconnectable between two side walls (4, 6) of said plurality when such walls are in said operative position thereby being, in said operative configuration of said two side walls, reversibly connectible and disconnectable to the remainder of the container.

16. The container (1) according to claim 1, wherein said reversible blocking means comprises reversible engaging means (8), located in correspondence of one or more pairs of contiguous side walls (4, 5; 5, 6; 6, 7; 7, 4) of said plurality, for blocking the walls of the pair the one with the other in said operative position.

17. The container (1) according to claim 2, wherein said reversible engaging means (8) comprises complementary Velcro® elements (81, 82) applied at each one of said pairs of contiguous side walls (4, 5; 5, 6; 6, 7; 7, 4).

18. The container (1) according to claim 1, comprising complementary Velcro® elements (111, 112, 41, 61) fastened to said partition wall (11) and to said two side walls (4, 6) for implementing said mutual reversible connection.

19. The container (1) according to claim 1, wherein said base (2) has a substantially rectangular contour in a plan view and wherein said plurality of side walls (4, 5, 6, 7) comprises four walls, each one rotatably connected to said base at a rectangle side.

20. The container (1) according to claim 1, comprising at least one side wall (4, 5, 6, 7) rotatably connected to said base (2) at an intermediate portion of the latter.

21. The container (1) according to claim 1, wherein said rotatable connection between at least one side wall (4, 5, 6, 7) and said base (2) is obtained by a peripheral seam (21).

22. The container (1) according to claim 1, comprising reversible fastening means (3) for blocking said base (2) onto the resting surface (P) of the trunk (B), located at a bottom face thereof.

23. The container (1) according to claim 8, wherein said reversible fastening means comprises at least one Velcro® element (3).

24. The container (1) according claim 1, comprising elastically strainable means (9) for retaining an item, applied at least at said at least one side wall (4, 5, 6, 7).

25. The container (1) according to claim 1, comprising closure means (10) apt to block the container (1) in a minimal encumbrance configuration in which the side wall or walls (4, 5, 6, 7) are rotated so as to be folded on said base (2).

26. The container (1) according to claim 11, comprising at least two opposite side walls (4, 6), and wherein said closure means (10) comprises a pair of complementary Velcro® elements (101, 102), each one fastened to a respective side wall of said two opposite walls.

27. The container (1) according to claim 1, wherein said base (2) and/or said at least one side wall (4, 5, 6, 7) comprises a polycarbonate honeycomb core and a polyester coating.

28. The container (1) according to claim 1, wherein said base (2) and said at least one side wall (4, 5, 6, 7) are implemented as distinct bodies coated by a common foldable lining implementing said rotatable connection between the base and the walls.
